(19) United States
(12) Patent Application Publication
(10) Pub. No.: US 2023/0107926 A1
(43) Pub. Date: Apr. 6, 2023

(54) A METHOD FOR TREATING A BIOLOGICAL OBJECT

(71) Applicant: OPTICEPT TECHNOLOGIES AB, LUND (SE)

(72) Inventors: Eda DEMIR WESTMAN, STAFFANSTORP (SE); Katarzyna DYMEK KRAKOWIAK, LUND (SE); Stephen KWAO, LUND (SE); Revekka Papaioannou, LUND (SE); Ahmad Husain, LUND (SE)

(21) Appl. No.: 17/800,742

(22) PCT Filed: Mar. 3, 2021
(86) PCT No.: PCT/SE2021/050184

§ 371 Date: Aug. 18, 2022

(30) Foreign Application Priority Data
Mar. 3, 2020 (SE) 2050235-7
Jun. 3, 2020 (SE) 2050637-4

(51) Int. Cl. A01N 3/02

(52) U.S. Cl. CPC A01N 3/02

(57) ABSTRACT

The present invention describes a method for treating a biological object being a cutting, root, sprout, budwood, root-stock, forest plant, fruit, vegetable, green leave, bulb, seed, or berry, said method comprising — arranging the biological object in an aqueous impregnation solution so that at least a portion of the biological object is immersed in the impregnation solution, but where at least another part of the biological object is kept free from aqueous impregnation solution; and — applying vacuum impregnation or pressure impregnation, preferably vacuum impregnation, to the aqueous impregnation solution when said at least portion of the biological object is immersed into the aqueous impregnation solution.

### FIELD OF THE INVENTION

The present invention relates to a method for treating a biological object being a cutting, root, sprout, budwood, rootstock, forest plant, fruit, vegetable, green leave, bulb, seed, or berry.

### SUMMARY OF THE INVENTION

The present invention relates to a method for treating a biological object being a cutting, root, sprout, budwood, rootstock, forest plant, fruit, vegetable, green leave, bulb, seed, or berry, said method comprising
arranging the biological object in an aqueous impregnation solution so that at least a portion of the biological object is immersed in the impregnation solution, but where at least another part of the biological object is kept free from aqueous impregnation solution; and
applying vacuum impregnation or pressure impregnation, preferably vacuum impregnation, to the aqueous impregnation solution when said at least portion of the biological object is immersed into the aqueous impregnation solution.

As should be understood from above, the present invention provides a method in which it is ensured that one part of the biological object is free from impregnation solution. For instance, for instance cuttings, it may be just a part of the cuttings. Moreover, in the case of root plants, then e.g. just the roots may be immersed into the impregnation solution. This aspect is an important and unique aspect of the present invention.

Furthermore, partial impregnation of the biological object to be treated is of interest according to the present invention. This means that the treatment is milder for the tissue and generates less stress. It is also probably easier for the tissue to recover since not all of the air spaces are flooded with the solution. On the other hand, it is of interest for the solution to reach the tissue so there is a kind of balance achieved. You could say, just enough to see the effect of the impregnation from the impregnation solution, but not too much so the plant is still able to recover and function afterwards.

According to the present invention, the visual impregnation shows different patterns, and there is no preferred part of the leaf or cutting that gets impregnated. However, the effect is seen in the entire plant, this means that active compounds are transported inside the plant, at least to some extent.

### Specific Embodiments of the Invention

Below there is provided some specific embodiments of the present invention.

According to one specific embodiment of the present invention, the method comprises exposing the biological object to vacuum impregnation or pressure impregnation, preferably vacuum impregnation, in an aqueous impregnation solution without performing a prior, simultaneous or subsequent PEF (pulsed electrical field) treatment. According to a second aspect of the present invention, the above is a starting point, i.e. where a method for vacuum impregnation is performed without a PEF treatment step. This is further explained below.

According to yet another embodiment, the aqueous impregnation solution comprises at least one additive being a vitamin, mineral, ethylene controller, antioxidant, hormone, nutrient, antimicrobial, or a combination thereof.

According to another embodiment, the aqueous impregnation solution comprises at least one additive of folic acid, gamma-aminobutyric acid (GABA), ethylene blockers, e.g. 1-methylcyclopropene (1-MCP), amino acids, e.g. cysteine, plant hormones, e.g. IBA, an antiseptic agent, e.g. a silver containing substance, such as silver nitrate, a surfactant, or a combination thereof. With reference to above it should be noted that some additives are suitable for some type of products to be treated, and other additives are suitable for others. As an example, silver additives, such as silver nitrate, may be suitable for cuttings etc., however not for food products, like fruits and the like. Furthermore, according to one specific embodiment, one or more surfactants is used as an additive. Such surfactants, for instance anionic surfactants, may be of interest to be involved in the impregnation solution to increase the impregnation level for some products.

The operational parameters are also of interest according to the present invention. According to one embodiment, the method involves vacuum impregnation in a minimum pressure range of 60 - 300 mbar. Furthermore, according to yet another embodiment of the present invention, the method is performed during a total treatment time for applying vacuum impregnation or pressure impregnation of less than 10 minutes, preferably less than 5 minutes, more preferably less than 3 minutes. According to yet another embodiment of the present invention, the method involves applying vacuum impregnation and wherein the total treatment time for applying vacuum impregnation is maximum 3 minutes, preferably maximum 1 minute, more preferably in the range of 5 seconds - 1 minute. As is notable from the above, the method according to the present invention is preferably performed by use of short vacuum impregnation cycles. This is further discussed below.

Furthermore, according to yet another embodiment, the method involves vacuum impregnation in at least two phases, said two phases being a falling step when the pressure is decreased to a certain low pressure and then a pressure rising step where the pressure is increased to atmospheric level, and wherein the total treatment time for applying vacuum impregnation for said at least two phases is maximum 3 minutes, preferably maximum 1 minute, more preferably in the range of 5 seconds - 1 minute. Moreover, according to yet another embodiment, the method also includes a minimum pressure holding step in which the low pressure is kept or substantially kept at the low pressure before the pressure rising step, and wherein the holding step preferably is performed during maximum 10 seconds, more preferably maximum 5 seconds. As mentioned, the above embodiments relate to the preferred direction of short cycle vacuum impregnation according to the present invention.

Moreover, according to yet another embodiment, the method involves several vacuum impregnation cycles, preferably from atmospheric pressure to the minimum pressure and back to atmospheric pressure again in each vacuum impregnation cycle.

According to one embodiment, the method also involves a step of applying PEF (pulsed electric field). This is a possible alternative, and may be suitable for some materials, however it is preferred to perform the vacuum impregnation without involving a PEF treatment step for most materials intended to be treated.

Other additional steps may be involved according to the present invention. As a first example, according to one embodiment, the method involves a subsequent washing step comprising immersing said biological object into water to wash sugars and/or other substances from the surface of the biological object. Moreover, according to yet another embodiment, the biological object is subjected to a cooling step after vacuum impregnation, preferably subsequent to a washing step, said cooling step being a recovering step. According to one embodiment, the cooling step is performed at a temperature of 5-10° C. Moreover, according to yet another embodiment, the cooling step is performed during at least 6 hours, preferably at least 12 hours.

Moreover, according to yet another embodiment, the method also comprises applying a drying step to the biological object, subsequent to vacuum impregnation, for removing water/moisture from surfaces of the biological object before packing the treated plant material.

Furthermore, according to one embodiment, the method also comprises an active step for preventing microbial contamination of the aqueous impregnation solution. According to one embodiment, the active step for preventing microbial contamination involves adding one or more antimicrobial agents to the aqueous impregnation solution, preferably wherein the active step for preventing microbial contamination involves an active treatment of the aqueous impregnation solution. According to one embodiment, the aqueous impregnation solution is recirculated and reused, preferably as an active step for preventing microbial contamination. Moreover, according to yet another embodiment, UV is used as a technology for implementation as the active treatment of the aqueous impregnation solution.

Moreover, according to yet another embodiment, the impregnation is a partial impregnation, preferably wherein the impregnation is a partial impregnation where the biological material receives a maximum of a 50% weight gain after the partial impregnation. This is yet another perspective relating to the partial impregnation referring to the method according to the present invention.

Furthermore, according to yet another embodiment, a resting period is applied subsequent to the vacuum or pressure impregnation. As an example, the resting period may be performed in a relative humidity of at least 60% and in a temperature range of 4-10° C. Moreover, according to yet another embodiment, the resting period involves removing water from surfaces of the biological object. Furthermore, the resting period may involve putting the biological object on a net material to remove water from surfaces of the biological object.

Moreover, according to another embodiment of the present invention, the method involves a subsequent freezing step. As mentioned above, cooling may be applied instead. In line with both these alternatives, according to one embodiment, the method involves storing the biological object in a controlled storing environment. According to one embodiment, the storing environment involves a temperature of 4-10° C. Furthermore, according to another embodiment, the storing environment involves a humidity of above 50%.

Furthermore, according to one embodiment, the storing is performed by incorporating the biological object into one or more package with modified atmosphere and/or including a moisture controlling agent, such as a desiccant.

### A Second Aspect of the Present Invention

According to a second aspect of the present invention, there is provided a method for treating a biological material, said method comprising exposing the biological material to vacuum impregnation or pressure impregnation, preferably vacuum impregnation, in an aqueous impregnation solution without performing a prior, simultaneous or subsequent PEF (pulsed electrical field) treatment.

Embodiments relating to this aspect is provided below in the part “clauses - a second aspect of the present invention”.

### EXPERIMENTS

Comparative trials were made to investigate the effect of a method according to the present invention, that is a method preferably involving vacuum impregnation and which definitely is free from any PEF step, and a method involving a PEF step, either alone or together with an impregnation step, and of course also compared with untreated control(s).

Cuttings of Pelargonium interspecific: Calliope M Dark Red was used as the testing material.

### Trials of Cuttings of Pelargonium

When testing the method according to the second aspect of the present invention, the following vacuum impregnation parameters (protocol) were used: A pressure falling time of 10 minutes, a holding time of the obtained low pressure of 1 minute and then 15 minutes rising time when the pressure was increased again to atmospheric pressure. The minimum pressure was set at 220 mbar and trehalose 10% was used as the impregnation solution.

For the PEF trial and step (not according to the present invention), the parameters used were the following: 500 V in continuous system, 250 µs pulse width and 50 PPV (pulses per volume), 0.3 KW.

For the group of cuttings that was subjected only to vacuum impregnation, that is by a method according to the present invention, an additional rinsing step was also performed.

Moreover, each group tested consisted of 80 unrooted cuttings, and not any repetitions were performed.

The results of the comparative trials are presented in diagram 1 in the drawing and in table 1 below. It should be noted that VI stands for vacuum impregnation. The method alternative with No PEF - only VI is a method according to the present invention, however the tested alternative with PEF + VI is not a part of the present invention.

When the pelargonium cuttings were received they were processed immediately.

After the treatment, the groups were placed in perforated trays and kept inside slightly opened boxes. The boxes were stored 7 days at 8° C.

The Control Day 1 was delivered to the greenhouse for sticking the following day after reception.

Moreover, the Control was stored in the original packaging 7 days at 8° C.

After 7 days of storage the cuttings were evaluated and counted. The damaged (due to Botrytis), rotten or withered ones are removed. These are called losses before sticking.

The rooting, losses and acceptability results were obtained 21 days after sticking.

For the results below the following may be said;
A cutting is considered rooted when at least one root is coming out from the substrate used.
A cutting is considered not rooted when it has no obvious roots after this period of time but shows signs of growth.
A cutting is considered loss when it is dead/damaged, has lost most of its leaves and hasn’t rooted.
A YPL (young plant) is considered acceptable if the growth is obvious, there are no signs of Botrytis, no damages in the leaves and it is rooted.

In diagram 1 in the drawing, results of the trial are shown.

Furthermore, below in table 1 the results in the diagram 1 are given.

TABLE 1

| | % Losses after storage | % Rooted | %Not rooted | % Acceptable YPL | % Losses |
|---|---|---|---|---|---|
| Control stuck Day 1 | 0 | 30 | 64 | 10 | 6 |
| Control (stored) | 0 | 54 | 35 | 25 | 12 |
| Trehalose 10% (No PEF —Only VI) — according to the present invention | 4 | 88 | 8 | 46 | 0 |
| Trehalose 10% (VI + PEF) | 0 | 75 | 15 | 35 | 10 |

It should be noted that data for losses after storage were obtained after 8 days of storage.

These results imply that the method according to the second aspect of the present invention, i.e. comprising a vacuum impregnation (VI) step without a PEF step, is more effective than a method involving both PEF and VI, when being compared for trials of cuttings of Pelargonium interspecific: Calliope M Dark Red. Furthermore, when comparing with the control, the method according to the present invention involving only vacuum impregnation and not PEF is proven to be very effective.

### Another Performed Trial - VI on Roses

Roses (variety: Athena) were purchased form a local distributor. The roses were transported from Kenya. The roses arrived at the test site 4 days after harvest.

The treatment according to the present invention was applied to the roses immediately after the arrival. The roses were placed vertically in an impregnation solution, making sure that the flower bud was not immersed in the impregnation solution, thus only the stem and leaves were immersed. The impregnation solution contained sugar (fructose at a concentration of 2-15 wt%). Vacuum was applied reaching a minimum pressure range of 60 - 300 mbar, and with a total treatment time of about 12 minutes.

In relation to above, it should be noted that the method disclosed above is totally possible to perform with short VI cycle(s). Preferred embodiments of the method according to the present invention, such as with reference to pressure and time are provided above and in the attached claims. Moreover, to exclude a PEF step is preferred.

Furthermore, the starting material used in this trial, namely cut flowers, are not intended as being part of the material to be treated according to the present invention. The trial here related to treatment of cut flowers should be regarded as a reference for the treatment of materials intended to be treated according to the present invention. As specified in the claims, the material intended to be treated according to the present invention is a cutting, root, sprout, budwood, rootstock, forest plant, fruit, vegetable, green leave, bulb, seed, or berry. According to one specific embodiment, the material to be treated is a cutting, root, sprout or budwood. Therefore, the present invention also embodies using a method according to the present invention, for treatment of a cutting, root, sprout, budwood, rootstock, forest plant, fruit, vegetable, green leave, bulb, seed, or berry, preferably for treatment of a material being a cutting, root, sprout or budwood.

To continue with the trial performed, after that the vacuum impregnation treatment was finished, the roses were taken out from the impregnation solution. They were then immersed in water, again excluding the flower buds, to wash the sugars from the surface and then placed in a cold room for 24 hours to recover. They were in this case not dried in any way.

After 24 hours the roses were moved to room temperature in order to evaluate the results at the end user conditions. They were stored in a vase, with only the lower part of the stems immersed in water, and the water was renewed every two days.

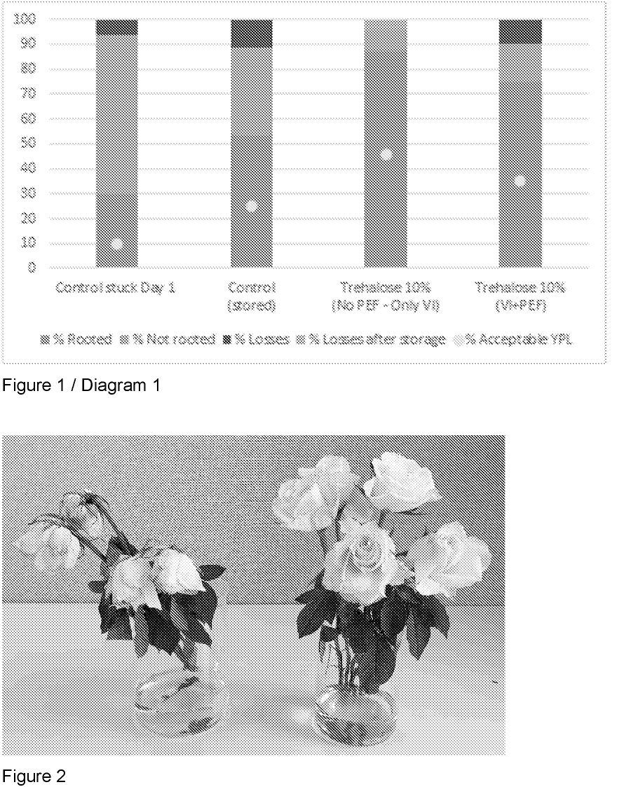

Results show a clear improvement of the general appearance of roses that were impregnated with sugar prior to storage (FIG. 2 in the drawing). The browning and wilting of the flower buds are delayed for the treated roses compared to the control. Also, the treated leaves preserve freshness better.

Roses were stored at room temperature for 13 days after the treatment (Right: roses treated according to the present invention, left: control roses, i.e. not treated).

It should be noted that also in this case PEF was not used as part of the method. This trial was performed with a method according to the present invention, that is with vacuum impregnation and without a PEF step.

### Clauses - a Second Aspect of the Present Invention

1. A method for treating a biological material, said method comprising exposing the biological material to vacuum impregnation or pressure impregnation, preferably vacuum impregnation, in an aqueous impregnation solution without performing a prior, simultaneous or subsequent PEF (pulsed electrical field) treatment.

2. The method according to claim 1, wherein the biological material is a plant material in the form of a cut flower, cutting, root, sprout, budwood, rootstock, forest plant, fruit, vegetable, green leave, bulb, seed, or berry.

3. The method according to claim 1 or 2, wherein the method comprises
arranging the biological material in an aqueous impregnation solution so that at least a portion of the biological material is immersed in the impregnation solution, but where at least another part of the biological material is kept free from aqueous impregnation solution; and
applying vacuum impregnation or pressure impregnation, preferably vacuum impregnation, to the aqueous impregnation solution when said at least portion of the biological material is immersed into the aqueous impregnation solution.

4. The method according to any of claims 1-3, wherein the method involves vacuum impregnation and the impregnation solution comprises at least one sugar component, preferably wherein said at least on sugar component is glucose, trehalose and/or fructose, or a sugar alcohol, preferably sorbitol, or a combination thereof.

5. The method according to any of claims 1-4, wherein the aqueous impregnation solution comprises at least one additive being a vitamin, mineral, ethylene controller, antioxidant, hormone, nutrient, antimicrobial, or a combination thereof.

6. The method according to any of claims 1-4, wherein the aqueous impregnation solution comprises at least one additive of folic acid, gamma-aminobutyric acid (GABA), ethylene blockers, e.g. 1-methylcyclopropene (1-MCP), amino acids, e.g. cysteine, plant hormones, e.g. IBA, an antiseptic agent, e.g. a silver containing substance, such as silver nitrate, a surfactant, or a combination thereof.

7. The method according to any of the preceding claims, wherein the method involves vacuum impregnation in a minimum pressure range of 60 - 300 mbar.

8. The method according to any of the preceding claims, wherein the method is performed during a total treatment time for applying vacuum impregnation or pressure impregnation of less than 10 minutes, preferably less than 5 minutes, more preferably less than 3 minutes.

9. The method according to claim 8, wherein the method involves applying vacuum impregnation and wherein the total treatment time for applying vacuum impregnation is maximum 3 minutes, preferably maximum 1 minute, more preferably in the range of 5 seconds - 1 minute.

10. The method according to claim 8 or 9, wherein the method involves vacuum impregnation in at least two phases, said two phases being a falling step when the pressure is decreased to a certain low pressure and then a pressure rising step where the pressure is increased to atmospheric level, and wherein the total treatment time for applying vacuum impregnation for said at least two phases is maximum 3 minutes, preferably maximum 1 minute, more preferably in the range of 5 seconds - 1 minute.

11. The method according to claim 10, wherein the method also includes a minimum pressure holding step in which the low pressure is kept or substantially kept at the low pressure before the pressure rising step, and wherein the holding step preferably is performed during maximum 10 seconds, more preferably maximum 5 seconds.

12. The method according to any of the preceding claims, wherein the method involves several vacuum impregnation cycles, preferably from atmospheric pressure to the minimum pressure and back to atmospheric pressure again in each vacuum impregnation cycle.

13. The method according to any of the preceding claims, wherein the method involves a subsequent washing step comprising immersing said biological object into water to wash sugars and/or other substances from the surface of the biological object.

14. The method according to any of the preceding claims, wherein the biological object is subjected to a cooling step after vacuum impregnation, preferably subsequent to a washing step, said cooling step being a recovering step.

15. The method according to claim 14, wherein the cooling step is performed at a temperature of 5-10° C.

16. The method according to claim 14 or 15, wherein the cooling step is performed during at least 6 hours, preferably at least 12 hours.

17. The according to any of the preceding claims, wherein the method also comprises applying a drying step to the biological object, subsequent to vacuum impregnation, for removing water/moisture from surfaces of the biological object before packing the treated plant material.

18. The method according to any of the preceding claims, wherein the method also comprises an active step for preventing microbial contamination of the aqueous impregnation solution.

19. The method according to claim 18, wherein the active step for preventing microbial contamination involves adding one or more antimicrobial agents to the aqueous impregnation solution, preferably wherein the active step for preventing microbial contamination involves an active treatment of the aqueous impregnation solution.

20. The method according to any of the preceding claims, wherein the impregnation is a partial impregnation, preferably wherein the impregnation is a partial impregnation where the biological material receives a maximum of a 50% weight gain after the partial impregnation.

21. The method according to any of the preceding claims, wherein a resting period is applied subsequent to the vacuum or pressure impregnation.

22. The method according to claim 21, wherein the resting period is performed in a relative humidity of at least 60% and in a temperature range of 4-10° C.

23. The method according to claim 21 or 22, wherein the resting period involves removing water from surfaces of the biological object.

24. The method according to any of claims 21-23, wherein the resting period involves putting the biological object on a net material to remove water from surfaces of the biological object.

25. The method according to any of the preceding claims, wherein the method involves a subsequent freezing step.

26. The method according to any of the preceding claims, wherein the method involves storing the biological object in a controlled storing environment.

27. The method according to claim 26, wherein the storing environment involves a temperature of 4-10° C.

28. The method according to claim 26 or 27, wherein the storing environment involves a humidity of above 50%.

29. The method according to any of claims 26-28, wherein the storing is performed by incorporating the biological object into one or more package with modified atmosphere and/or including a moisture controlling agent, such as a desiccant.

1. A method for treating a biological object being a cutting, root, sprout, budwood, rootstock, forest plant, fruit, vegetable, green leave, bulb, seed, or berry, said method comprising
arranging the biological object in an aqueous impregnation solution so that at least a portion of the biological object is immersed in the impregnation solution, but where at least another part of the biological object is kept free from aqueous impregnation solution; and
applying vacuum impregnation or pressure impregnation, preferably vacuum impregnation, to the aqueous impregnation solution when said at least portion of the biological object is immersed into the aqueous impregnation solution.

2. The method according to claim 1, wherein the method comprises exposing the biological object to vacuum impregnation or pressure impregnation, preferably vacuum impregnation, in an aqueous impregnation solution without performing a prior, simultaneous or subsequent PEF (pulsed electrical field) treatment.

3. The method according to claim 1, wherein the aqueous impregnation solution comprises at least one additive being a vitamin, mineral, ethylene controller, antioxidant, hormone, nutrient, antimicrobial, or a combination thereof.

4. The method according to claim 1, wherein the aqueous impregnation solution comprises at least one additive of folic acid, gamma-aminobutyric acid (GABA), ethylene blockers, e.g. 1-methylcyclopropene (1-MCP), amino acids, e.g. cysteine, plant hormones, e.g. IBA, an antiseptic agent, e.g. a silver containing substance, such as silver nitrate, a surfactant, or a combination thereof.

5. The method according to claim 1 , wherein the method involves vacuum impregnation in a minimum pressure range of 60 - 300 mbar.

6. The method according to claim 1 , wherein the method is performed during a total treatment time for applying vacuum impregnation or pressure impregnation of less than 10 minutes, preferably less than 5 minutes, more preferably less than 3 minutes.

7. The method according to claim 6, wherein the method involves applying vacuum impregnation and wherein the total treatment time for applying vacuum impregnation is maximum 3 minutes, preferably maximum 1 minute, more preferably in the range of 5 seconds - 1 minute.

8. The method according to claim 6, wherein the method involves vacuum impregnation in at least two phases, said two phases being a falling step when the pressure is decreased to a certain low pressure and then a pressure rising step where the pressure is increased to atmospheric level, and wherein the total treatment time for applying vacuum impregnation for said at least two phases is maximum 3 minutes, preferably maximum 1 minute, more preferably in the range of 5 seconds - 1 minute.

9. The method according to claim 8, wherein the method also includes a minimum pressure holding step in which the low pressure is kept or substantially kept at the low pressure before the pressure rising step, and wherein the holding step preferably is performed during maximum 10 seconds, more preferably maximum 5 seconds.

10. The method according to claim 1 , wherein the method involves several vacuum impregnation cycles, preferably from atmospheric pressure to the minimum pressure and back to atmospheric pressure again in each vacuum impregnation cycle.

11. The method according to claim 1, wherein the method also involves a step of applying PEF (pulsed electric field).

12. The method according to claim 1 , wherein the method involves a subsequent washing step comprising immersing said biological object into water to wash sugars and/or other substances from the surface of the biological object.

13. The method according to claim 1 , wherein the biological object is subjected to a cooling step after vacuum impregnation, preferably subsequent to a washing step, said cooling step being a recovering step.

14. The method according to claim 13, wherein the cooling step is performed at a temperature of 5-10° C.

15. The method according to claim 13, wherein the cooling step is performed during at least 6 hours, preferably at least 12 hours.

16. The method according to claim 1 , wherein the method also comprises applying a drying step to the biological object, subsequent to vacuum impregnation, for removing water/moisture from surfaces of the biological object before packing the treated plant material.

17. The method according to claim 1 , wherein the method also comprises an active step for preventing microbial contamination of the aqueous impregnation solution.

18. The method according to claim 17, wherein the active step for preventing microbial contamination involves adding one or more antimicrobial agents to the aqueous impregnation solution, preferably wherein the active step for preventing microbial contamination involves an active treatment of the aqueous impregnation solution.

19. The method according to claim 1 , wherein the impregnation is a partial impregnation, preferably wherein the impregnation is a partial impregnation where the biological material receives a maximum of a 50% weight gain after the partial impregnation.

20. The method according to claim 1 , wherein a resting period is applied subsequent to the vacuum or pressure impregnation.

21. The method according to claim 20, wherein the resting period is performed in a relative humidity of at least 60% and in a temperature range of 4-10° C.

22. The method according to claim 20, wherein the resting period involves removing water from surfaces of the biological object.

23. The method according to claim 20, wherein the resting period involves putting the biological object on a net material to remove water from surfaces of the biological object.

24. The method according to claim 1 , wherein the method involves a subsequent freezing step.

25. The method according to claim 1 , wherein the method involves storing the biological object in a controlled storing environment.

26. The method according to claim 25, wherein the storing environment involves a temperature of 4-10° C.

27. The method according to claim 25, wherein the storing environment involves a humidity of above 50%.

28. The method according to claim 26, wherein the storing is performed by incorporating the biological object into one or more package with modified atmosphere and/or including a moisture controlling agent, such as a desiccant.

29. A method for treating a biological material, said method comprising exposing the biological material to vacuum impregnation or pressure impregnation, preferably vacuum impregnation, in an aqueous impregnation solution without performing a prior, simultaneous or subsequent PEF (pulsed electrical field) treatment, and wherein the biological material is a plant material in the form of a cut flower, cutting, root, sprout, budwood, rootstock, forest plant, fruit, vegetable, green leave, bulb, seed, or berry.
